(19) United States
(12) Patent Application Publication
(10) Pub. No.: US 2026/0243468 A1
(43) Pub. Date: Aug. 20, 2026

(54) HOT WATER SUPPLY HEATING DEVICE

(71) Applicant: NORITZ CORPORATION, Hyogo (JP)

(72) Inventors: Taisuke SHIMIZU, Hyogo (JP); Yasushi MORITA, Hyogo (JP)

(73) Assignee: NORITZ CORPORATION, Hyogo (JP)

(21) Appl. No.: 19/446,873

(22) Filed: Jan. 12, 2026

(30) Foreign Application Priority Data
Feb. 20, 2025 (JP) 2025-025663

(51) Int. Cl. F24H 15/315; F24H 15/215; F24H 15/219; F24H 15/31; G05D 23/19

(52) U.S. Cl. CPC F24H 15/315; F24H 15/215; F24H 15/219; F24H 15/31; G05D 23/1931

(57) ABSTRACT

A hot water supply heating device includes heat exchanger that heats tap water by heat medium from water supply passage provided with distribution valve and outputs hot water to hot water outflow passage; bypass passage branched from water supply passage at distribution valve and connected to hot water outflow passage; control part that supplies hot water at hot water supply set temperature by valve position adjustment of distribution valve; and notification part. The control part includes standard valve position setting part for distribution valve corresponding to combination of hot water supply set temperature and water supply temperature, and when hot water is supplied in normal mode, in case where an adjustment amount from standard valve position set by standard valve position setting part to adjusted valve position exceeds an adjustment normal range, control part transitions according to adjustment amount to any one of first mode; second mode; or third mode.

### CROSS-REFERENCE TO RELATED APPLICATION

This application claims the priority benefits of Japanese application no. 2025-025663, filed on February 20, 2025. The entirety of the above-mentioned patent application is hereby incorporated by reference herein and made a part of this specification.

### BACKGROUND

### Technical Field

The disclosure relates to a hot water supply heating device including a heating function and a hot water supply function, and particularly relates to hot water supply operation when scale accumulation occurs in a heat exchanger for hot water supply.

### Related Art

Conventionally, hot water supply devices have been widely used that heat tap water and adjust the temperature by mixing the heated hot water with unheated tap water in order to supply hot water at a hot water supply set temperature. For example, Patent Document 1 describes a hot water supply device that heats tap water in a heat exchanger using combustion heat and supplies hot water by mixing the heated hot water with unheated tap water.

Normally, tap water contains mineral components such as calcium. The more mineral components contained in the tap water (the higher the hardness), and the higher the temperature becomes when the tap water is heated, the more easily the mineral components tend to precipitate. Therefore, the mineral components in the tap water precipitate due to heating in the heat exchanger and accumulate as scale inside the heat exchanger. Since the scale narrows the passage for hot water inside the heat exchanger, the flow rate of hot water flowing through the heat exchanger decreases.

Therefore, the hot water supply device of Patent Document 1 is equipped with a scale collection part on the outlet side of the heat exchanger, and in addition to the increase in water flow resistance due to scale accumulation inside the heat exchanger, the water flow resistance caused by the collected scale makes the decrease in flow rate on the heat exchanger side greater than in the case without the collection part. Then, based on the rise in hot water outflow temperature from the heat exchanger accompanying this flow rate decrease, or the difference between the opening degree of the flow rate adjustment valve of the bypass passage and the initial setting opening degree accompanying the rise in hot water outflow temperature, the occurrence of scale clogging is detected and notified.

Moreover, Patent Document 2 describes detecting scale clogging by utilizing the fact that since heat exchange with tap water is hindered by scale accumulation, the temperature of the heat exchanger body heated by combustion heat becomes higher than when there is no scale accumulation.

### Citation List

### Patent Document

[Patent Document 1] Japanese Patent Application Laid-Open Publication No. 2010-261651

[Patent Document 2] Japanese Patent No. 6398325

On the other hand, hot water supply heating devices having a heating function that heats a heat medium for heating to a predetermined temperature and supplies it to an external heating terminal, and a hot water supply function that heats tap water in a heat exchanger for hot water supply using the heated heat medium and supplies hot water, are widely used. Even in such hot water supply heating devices that heat tap water with a heat medium for heating that is not as hot as combustion gas, in regions where the hardness of tap water is high, scale may accumulate inside the heat exchanger for hot water supply, reducing heat exchange efficiency, and there is also a risk that the passage for hot water inside the heat exchanger may be blocked by scale. Therefore, there is a demand for detecting scale accumulation in the heat exchanger for hot water supply, and there is also a demand for supplying hot water while avoiding blockage even when scale accumulation is detected.

However, since the heat medium for heating is not as hot as combustion gas, it is not easy to detect scale accumulation based on changes in the body temperature of the heat exchanger as in Patent Document 2. Moreover, in Patent Document 1, when scale accumulation is detected, the combustion heat generated is reduced, and the temperature of the hot water for hot water supply heated in the heat exchanger is lowered to supply hot water, but there are cases where it is not preferable to lower the temperature of the heat medium, for example during heating.

Therefore, the disclosure aims to provide a hot water supply heating device capable of supplying hot water while avoiding blockage according to the accumulation condition of scale.

### SUMMARY

A hot water supply heating device of the disclosure is characterized in including a heat exchanger that heats tap water supplied from a water supply passage by heat exchange with a heat medium for heating and outputs hot water to a hot water outflow passage; a distribution valve installed in the water supply passage; a bypass passage branched from the water supply passage at the distribution valve and connected to the hot water outflow passage; a control part that adjusts a distribution ratio to the heat exchanger and the bypass passage by adjusting a valve position of the distribution valve so as to supply hot water at a hot water supply set temperature; and a notification part that notifies by display or sound. The hot water supply heating device includes a water supply temperature detection part that detects a water supply temperature of tap water in the water supply passage; a hot water outflow temperature detection part that detects a hot water outflow temperature of hot water at an outlet of the heat exchanger; and a hot water supply temperature detection part that detects a hot water supply temperature of hot water at a downstream side of a connection part with the bypass passage in the hot water outflow passage. The control part includes a standard valve position setting part that sets a standard valve position of the distribution valve corresponding to a combination of the hot water supply set temperature and the water supply temperature, and when hot water is supplied in a normal mode that adjusts the valve position such that the hot water supply temperature converges to the hot water supply set temperature, in a case where an adjustment amount from the standard valve position set by the standard valve position setting part to a current valve position converged to the hot water supply set temperature exceeds a preset adjustment normal range, the control part transitions according to the adjustment amount to any one of a first mode that performs notification by the notification part to prompt cleaning of the heat exchanger and permits hot water supply similar to the normal mode; a second mode that performs the notification and permits hot water supply with a lowered hot water outflow temperature; or a third mode that performs the notification and prohibits hot water supply.

A hot water supply heating device of the disclosure is characterized in including a heat exchanger that heats tap water supplied from a water supply passage by heat exchange with a heat medium for heating and outputs hot water to a hot water outflow passage; a distribution valve installed in the water supply passage; a bypass passage branched from the water supply passage at the distribution valve and connected to the hot water outflow passage; a control part that adjusts a distribution ratio to the heat exchanger and the bypass passage by adjusting a valve position of the distribution valve so as to supply hot water at a hot water supply set temperature; and a notification part that notifies by display or sound. The hot water supply heating device includes a water supply temperature detection part that detects a water supply temperature of tap water in the water supply passage; a hot water outflow temperature detection part that detects a hot water outflow temperature of hot water at an outlet of the heat exchanger; and a hot water supply temperature detection part that detects a hot water supply temperature of hot water at a downstream side of a connection part with the bypass passage in the hot water outflow passage. The control part includes an inspection mode for inspecting scale accumulation in the heat exchanger, and when hot water is supplied in the inspection mode with the distribution valve set to a predetermined inspection valve position, the control part transitions, according to a temperature difference between a predicted hot water supply temperature calculated based on a distribution ratio corresponding to the inspection valve position; the water supply temperature; and the hot water outflow temperature, and an actual hot water supply temperature, to any one of a normal mode that adjusts the valve position such that the hot water supply temperature converges to the hot water supply set temperature; a first mode that performs notification by the notification part to prompt cleaning of the heat exchanger and permits hot water supply similar to the normal mode; a second mode that performs the notification and permits hot water supply with a lowered hot water outflow temperature; or a third mode that performs the notification and prohibits hot water supply.

### BRIEF DESCRIPTION OF THE DRAWINGS

FIG. 1 is a configuration diagram of a hot water supply heating device according to an embodiment of the disclosure.

FIG. 2 is an exploded perspective diagram of a main part of the water supply distribution valve of FIG. 1.

FIG. 3 is an exploded perspective diagram of the valve body of FIG. 2.

FIG. 4 is a diagram showing an adjustment range of the valve position of the water supply distribution valve.

FIG. 5 is a flowchart of scale accumulation estimation according to the embodiment.

FIG. 6 is a diagram showing an example of a temperature adjustment table.

FIG. 7 is a flowchart of scale accumulation estimation in the inspection mode.

### DESCRIPTION OF THE EMBODIMENTS

A hot water supply heating device of the disclosure of first aspect is characterized in including a heat exchanger that heats tap water supplied from a water supply passage by heat exchange with a heat medium for heating and outputs hot water to a hot water outflow passage; a distribution valve installed in the water supply passage; a bypass passage branched from the water supply passage at the distribution valve and connected to the hot water outflow passage; a control part that adjusts a distribution ratio to the heat exchanger and the bypass passage by adjusting a valve position of the distribution valve so as to supply hot water at a hot water supply set temperature; and a notification part that notifies by display or sound. The hot water supply heating device includes a water supply temperature detection part that detects a water supply temperature of tap water in the water supply passage; a hot water outflow temperature detection part that detects a hot water outflow temperature of hot water at an outlet of the heat exchanger; and a hot water supply temperature detection part that detects a hot water supply temperature of hot water at a downstream side of a connection part with the bypass passage in the hot water outflow passage. The control part includes a standard valve position setting part that sets a standard valve position of the distribution valve corresponding to a combination of the hot water supply set temperature and the water supply temperature, and when hot water is supplied in a normal mode that adjusts the valve position such that the hot water supply temperature converges to the hot water supply set temperature, in a case where an adjustment amount from the standard valve position set by the standard valve position setting part to a current valve position converged to the hot water supply set temperature exceeds a preset adjustment normal range, the control part transitions according to the adjustment amount to any one of a first mode that performs notification by the notification part to prompt cleaning of the heat exchanger and permits hot water supply similar to the normal mode; a second mode that performs the notification and permits hot water supply with a lowered hot water outflow temperature; or a third mode that performs the notification and prohibits hot water supply.

According to the above configuration, when hot water is supplied in the normal mode that adjusts the valve position of the distribution valve such that the hot water supply temperature converges to the hot water supply set temperature, in a case where the adjustment amount, which is the deviation of the valve position when converged to the hot water supply set temperature, relative to the standard valve position corresponding to the combination of the water supply temperature and the hot water supply set temperature exceeds the normal range, the control part transitions to any one of the first to third modes according to the adjustment amount. In the first to third modes, notification prompting cleaning of the heat exchanger is performed, so scale accumulation may be notified. Moreover, in the first to third modes transitioned to according to the adjustment amount, control according to the accumulation condition of scale estimated from the adjustment amount is performed, and hot water may be supplied while avoiding blockage.

A hot water supply heating device of the disclosure of second aspect is characterized in including a heat exchanger that heats tap water supplied from a water supply passage by heat exchange with a heat medium for heating and outputs hot water to a hot water outflow passage; a distribution valve installed in the water supply passage; a bypass passage branched from the water supply passage at the distribution valve and connected to the hot water outflow passage; a control part that adjusts a distribution ratio to the heat exchanger and the bypass passage by adjusting a valve position of the distribution valve so as to supply hot water at a hot water supply set temperature; and a notification part that notifies by display or sound. The hot water supply heating device includes a water supply temperature detection part that detects a water supply temperature of tap water in the water supply passage; a hot water outflow temperature detection part that detects a hot water outflow temperature of hot water at an outlet of the heat exchanger; and a hot water supply temperature detection part that detects a hot water supply temperature of hot water at a downstream side of a connection part with the bypass passage in the hot water outflow passage. The control part includes an inspection mode for inspecting scale accumulation in the heat exchanger, and when hot water is supplied in the inspection mode with the distribution valve set to a predetermined inspection valve position, the control part transitions, according to a temperature difference between a predicted hot water supply temperature calculated based on a distribution ratio corresponding to the inspection valve position; the water supply temperature; and the hot water outflow temperature, and an actual hot water supply temperature, to any one of a normal mode that adjusts the valve position such that the hot water supply temperature converges to the hot water supply set temperature; a first mode that performs notification by the notification part to prompt cleaning of the heat exchanger and permits hot water supply similar to the normal mode; a second mode that performs the notification and permits hot water supply with a lowered hot water outflow temperature; or a third mode that performs the notification and prohibits hot water supply.

According to the above configuration, when hot water is supplied in the inspection mode with the valve position of the distribution valve set to the inspection valve position, the control part transitions to any one of the normal mode or the first to third modes according to the temperature difference between the predicted hot water supply temperature calculated based on the distribution ratio corresponding to the inspection valve position; the water supply temperature; and the hot water outflow temperature, and the actual hot water supply temperature. In the first to third modes, notification prompting cleaning of the heat exchanger is performed, so scale accumulation may be notified. Moreover, in the first to third modes transitioned to according to the temperature difference, control according to the accumulation condition of scale estimated from the temperature difference is performed, and hot water may be supplied while avoiding blockage.

A hot water supply heating device of the disclosure of third aspect is characterized in that, in the disclosure of second aspect, the control part sets the inspection valve position based on the water supply temperature such that the predicted hot water supply temperature does not exceed a preset reference temperature.

According to the above configuration, when hot water is supplied at the inspection valve position, hot water may be supplied at a hot water supply temperature that does not exceed a reference temperature set such that there is no risk of burns, for example, so scale accumulation inspection can be performed safely.

A hot water supply heating device of the disclosure of fourth aspect is characterized in that, in any one of the disclosures of first aspect to third aspect, the distribution valve includes, in an adjustment range of the valve position, a distribution ratio adjustment range for adjusting the distribution ratio, a flow rate adjustment range for adjusting a flow rate while maintaining the distribution ratio constant, and a closing range for making the flow rate zero.

According to the above configuration, when transitioning to the third mode to prohibit hot water supply, the valve position of the distribution valve may be adjusted to the closing range such that hot water does not come out even when the hot water faucet is opened, and it may be notified that hot water cannot be supplied.

According to the hot water supply heating device of the disclosure, hot water may be supplied while avoiding blockage according to the accumulation condition of scale.

Hereinafter, modes for carrying out the disclosure will be described based on embodiments.

### Embodiment

First, the configuration of a hot water supply heating device 10 will be described.

The hot water supply heating device 10 has a heating function that performs heating by circulating a heat medium heated to a predetermined temperature using combustion heat between the device and an external heating terminal through an external hot water heating circuit. Moreover, the hot water supply heating device 10 has a hot water supply function that heats tap water using heat of the heat medium at a predetermined temperature, and supplies hot water adjusted to a hot water supply set temperature by mixing this heated tap water (hot water) with unheated tap water.

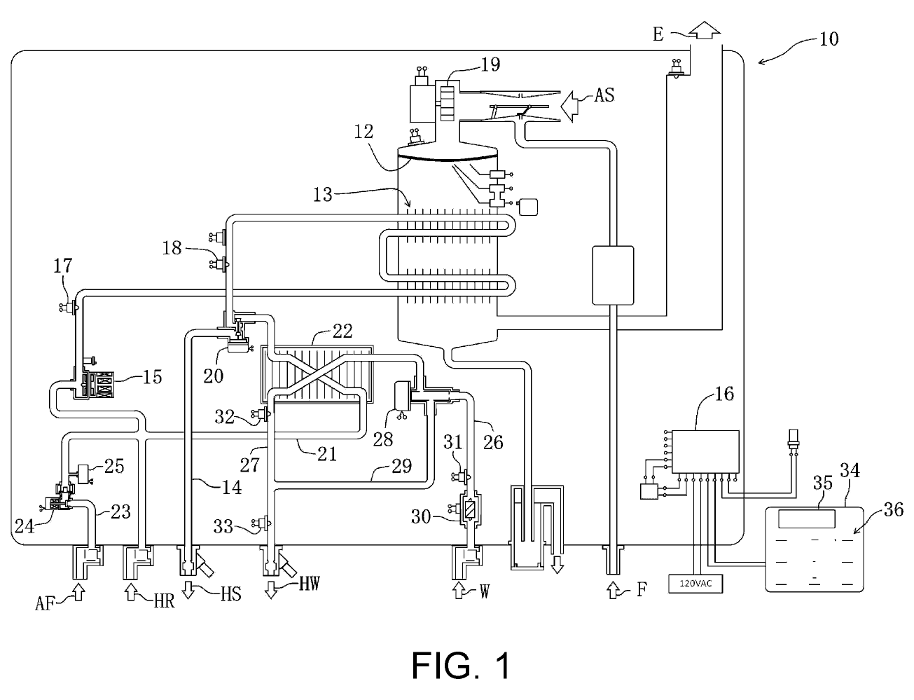

As shown in FIG. 1, the hot water supply heating device 10 includes a combustion part 12, a heating heat exchanger 13 that heats a heat medium, a heating passage 14 for connecting this heating heat exchanger 13 to an external hot water heating circuit, a heating pump 15 provided on the upstream side of the heating heat exchanger 13 in the heating passage 14, and a control part 16 that controls heating and hot water supply. The heating pump 15 causes the heat medium to flow so as to be supplied to the heating heat exchanger 13 during combustion of the combustion part 12.

In the heating passage 14, an inlet thermistor 17 is installed on the inlet side of the heating heat exchanger 13, and an outlet thermistor 18 is installed on the outlet side of the heating heat exchanger 13. The inlet thermistor 17 detects the temperature of the heat medium supplied to the heating heat exchanger 13. The outlet thermistor 18 detects the temperature of the heat medium heated by the heating heat exchanger 13. Based on the temperature of the heat medium detected by these thermistors, the combustion in the combustion part 12, the heat medium flow rate by the heating pump 15, and the like are controlled by the control part 16 such that the temperature of the heated heat medium becomes a predetermined temperature (target heat medium temperature) of, for example, 85°C.

To the combustion part 12, supply air indicated by arrow AS and fuel gas supplied as indicated by arrow F are mixed and supplied by driving of a combustion fan 19. The amount of combustion heat generated by combustion of the fuel gas in the combustion part 12 is adjusted by the rotation speed of the combustion fan 19. The heating heat exchanger 13 performs heat exchange between the combustion gas generated in the combustion part 12 and the heat medium flowing through the heating passage 14, and heats the heat medium to the target heat medium temperature. The combustion gas whose temperature has decreased due to heat exchange is exhausted to the outside as indicated by arrow E.

A hot water supply heating distribution valve 20 is installed on the downstream side of the heating heat exchanger 13 in the heating passage 14. In this hot water supply heating distribution valve 20, a heating bypass passage 21 is branched from the heating passage 14, and this heating bypass passage 21 is connected to the upstream side of the heating pump 15 in the heating passage 14. In the heating bypass passage 21, a hot water supply heat exchanger 22 (heat exchanger) that heats tap water for hot water supply by heat exchange with the heated heat medium is installed.

The hot water supply heating distribution valve 20 distributes the heat medium heated by the heating heat exchanger 13 to the heating passage 14 and the heating bypass passage 21. By adjusting the distribution ratio of this hot water supply heating distribution valve 20, heating operation only, hot water supply operation only, or simultaneous operation of heating and hot water supply may be performed.

The heat medium distributed to the heating passage 14 is supplied to the heating terminal through the hot water heating circuit as indicated by arrow HS. The heat medium returning from the heating terminal through the hot water heating circuit as indicated by arrow HR is supplied to the heating heat exchanger 13 through the heating pump 15. The heat medium distributed to the heating bypass passage 21 decreases in temperature by heat exchange with tap water in the hot water supply heat exchanger 22. The heat medium that has passed through this hot water supply heat exchanger 22 is supplied to the heating heat exchanger 13 through the heating pump 15.

A replenishment passage 23 for replenishing heat medium as indicated by arrow AF is connected to the upstream side of the heating pump 15 in the heating passage 14. This replenishment passage 23 is equipped with an on-off valve 24 that opens and closes the replenishment passage 23, and a pressure sensor 25 on the downstream side of this on-off valve 24.

A water supply passage 26 that supplies tap water from a water main as indicated by arrow W, and a hot water outflow passage 27 that outputs hot water heated by the hot water supply heat exchanger 22 from the hot water supply heat exchanger 22 are connected to the hot water supply heat exchanger 22. A water supply distribution valve 28 (distribution valve) is installed in the water supply passage 26. In the water supply distribution valve 28, a water supply bypass passage 29 (bypass passage) is branched from the water supply passage 26, and this water supply bypass passage 29 is connected to the hot water outflow passage 27.

The water supply distribution valve 28 distributes the supplied tap water to the hot water supply heat exchanger 22 side and the water supply bypass passage 29 side, and adjusts the distribution ratio and the flow rate of tap water passing through the water supply distribution valve 28. The hot water heated by the hot water supply heat exchanger 22 is mixed with unheated tap water supplied from the water supply bypass passage 29 in the hot water outflow passage 27 and temperature-adjusted to reach the hot water supply set temperature, and is supplied as hot water from the hot water outflow passage 27 as indicated by arrow HW.

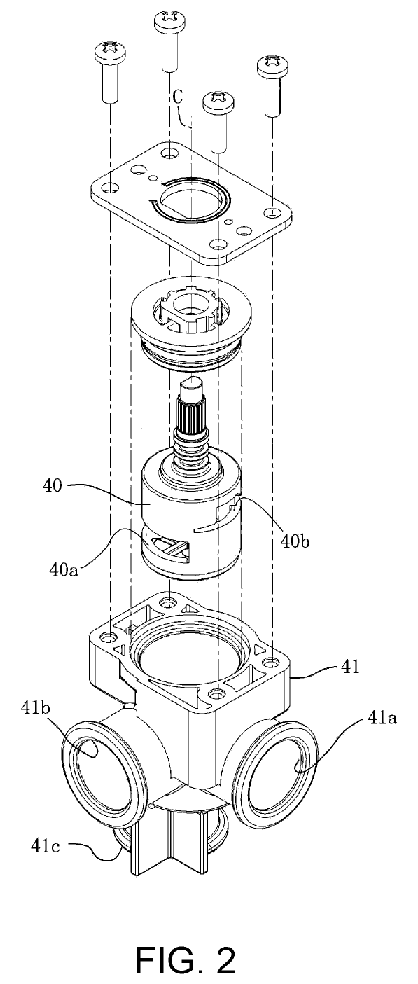

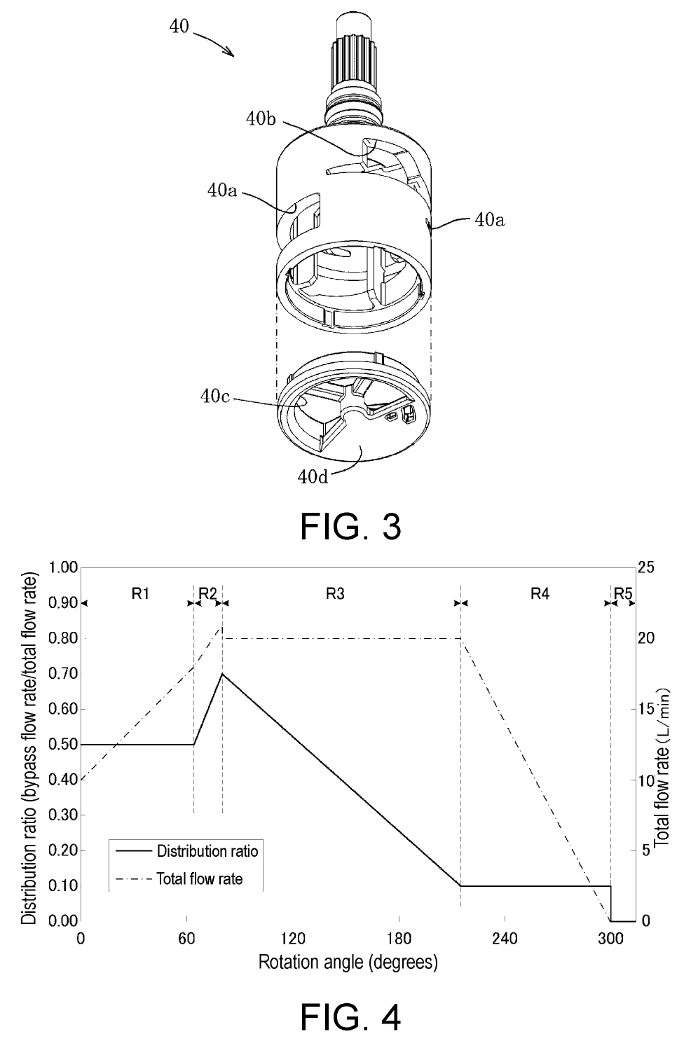

As shown in FIG. 2 and FIG. 3, the water supply distribution valve 28 is configured such that a cylindrical valve body 40 having a rotation shaft rotated by, for example, a stepping motor is rotatably housed in a main body part 41. The main body part 41 has a leading-out port 41a to the hot water supply heat exchanger 22, a leading-out port 41b to the water supply bypass passage 29 side, and a leading-in port 41c for tap water.

The side wall part of the cylindrical valve body 40 has an opening part 40a corresponding to the hot water supply heat exchanger 22 side and an opening part 40b corresponding to the water supply bypass passage 29 side. Moreover, the cylindrical valve body 40 has an opening part 40c corresponding to the leading-in port 41c for tap water in a bottom wall part 40d of the valve body 40. The opening parts 40a and 40b are formed such that the length in the direction parallel to a center shaft C varies depending on the circumferential position of the side wall part. The opening part 40c is formed in a shape approximating a semicircle whose center coincides with the center shaft C.

The side wall part and the bottom wall part 40d of the cylindrical valve body 40 housed in the main body part 41 slide against the inner wall of the main body part 41, and tap water flowing in from the leading-in port 41c is led into the valve body 40 through the opening part 40c. The tap water led into this valve body 40 is distributed to the hot water supply heat exchanger 22 side and the water supply bypass passage 29 side from the corresponding leading-out ports 41a and 41b through the two opening parts 40a and 40b.

This cylindrical valve body 40 is rotated about its center shaft C. By this, the opening areas of the opening parts 40a and 40b corresponding to the two leading-out ports 41a and 41b of the main body part 41 are respectively changed to adjust the distribution ratio. Moreover, by rotating the valve body 40, the opening area of the opening part 40c corresponding to the leading-in port 41c for tap water is changed, for example, while maintaining the distribution ratio, to adjust the flow rate of tap water flowing through the water supply distribution valve 28. For example, as shown in FIG. 4, the water supply distribution valve 28 is adjusted in the range of rotation angle 0 degrees to 310 degrees, and within this adjustment range, there is a range for adjusting the distribution ratio (range R3 of 80 degrees to 215 degrees), a range for adjusting the flow rate (total flow rate) flowing through this water supply distribution valve 28 while maintaining the distribution ratio constant (range R1 of 0 degrees to 60 degrees, range R4 of 215 degrees to 300 degrees), and a range for closing the water supply passage 26 by reducing the flow rate to zero (range R5 of 300 degrees to 310 degrees).

As shown in FIG. 1, a water supply flow rate sensor 30 and a water supply thermistor 31 (water supply temperature detection part) are installed upstream side of the water supply distribution valve 28 in the water supply passage 26. The water supply flow rate sensor 30 detects the flow rate of tap water supplied to the water supply distribution valve 28, that is, the flow rate of hot water supplied to a hot water supply passage 4. The water supply thermistor 31 detects the temperature of tap water supplied to the water supply distribution valve 28 (water supply temperature).

In the hot water outflow passage 27, a hot water outflow thermistor 32 (hot water outflow temperature detection part) is installed on the hot water supply heat exchanger 22 side of the connection part with the water supply bypass passage 29, and a hot water supply thermistor 33 (hot water supply temperature detection part) is installed downstream of the connection part. The hot water outflow thermistor 32 detects the hot water outflow temperature of hot water heated by the hot water supply heat exchanger 22. The hot water supply thermistor 33 detects the hot water supply temperature of hot water supplied to the hot water supply passage 4. The control part 16 controls the distribution ratio and the like of the water supply distribution valve 28 such that the hot water supply temperature detected by this hot water supply thermistor 33 ultimately converges to a preset hot water supply set temperature.

Next, the control part 16 will be described.

The control part 16 is communicatively connected to various sensors such as the inlet thermistor 17, and receives the detection signals and the like. Then, based on the received detection signals, the control part 16 controls the combustion fan 19, the heating pump 15, the hot water supply heating distribution valve 20, the water supply distribution valve 28, and the like, thereby controlling each operation of heating operation, hot water supply operation, and simultaneous operation of heating and hot water supply.

An operation terminal 34 is connected to the control part 16. The operation terminal 34 includes a display part 35 capable of displaying information such as various temperatures and operation states, an audio output part (not shown) that sounds a buzzer and the like, and a switch part 36 for performing setting operations and the like. The display part 35 and the audio output part correspond to the notification part of the hot water supply heating device 10. By operating the operation terminal 34, setting of the hot water supply set temperature, setting of the target heat medium temperature, and the like are performed.

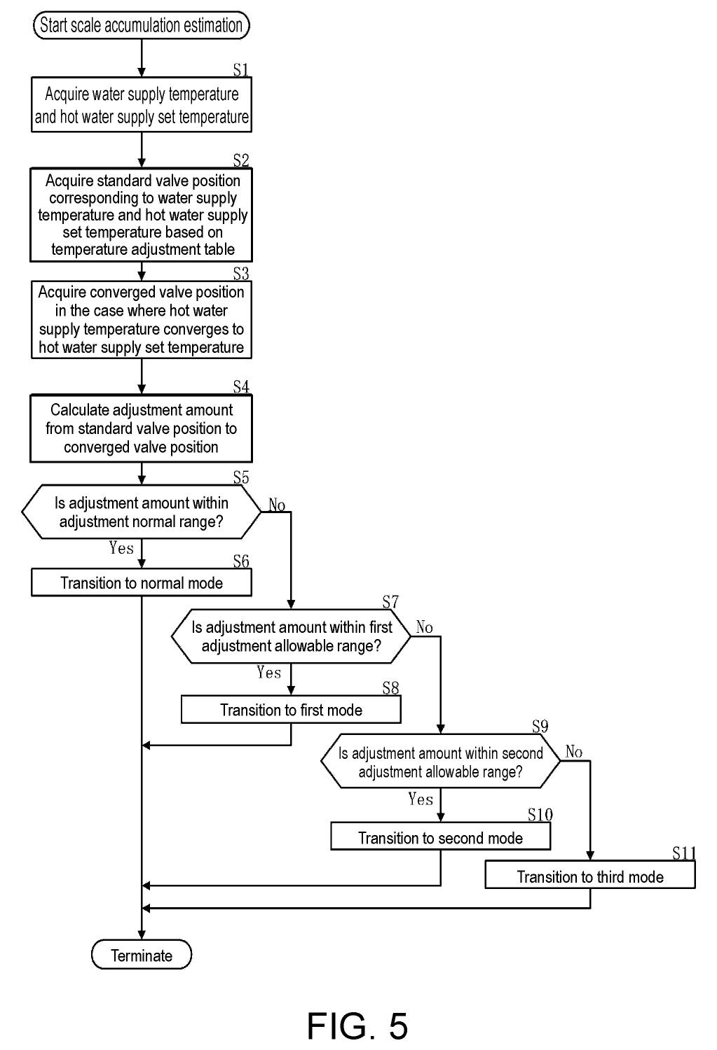

The control part 16 is configured to estimate the accumulation condition of scale in the hot water supply heat exchanger 22 based on the valve position represented by the rotation angle of the valve body 40 of the water supply distribution valve 28 during hot water supply operation, and to perform appropriate operation according to the accumulation condition. The valve position may also be represented by the number of steps of the stepping motor corresponding to the rotation angle. This scale accumulation estimation will be described based on FIG. 5. Si (i=1, 2, ...) in the figure represents the control step.

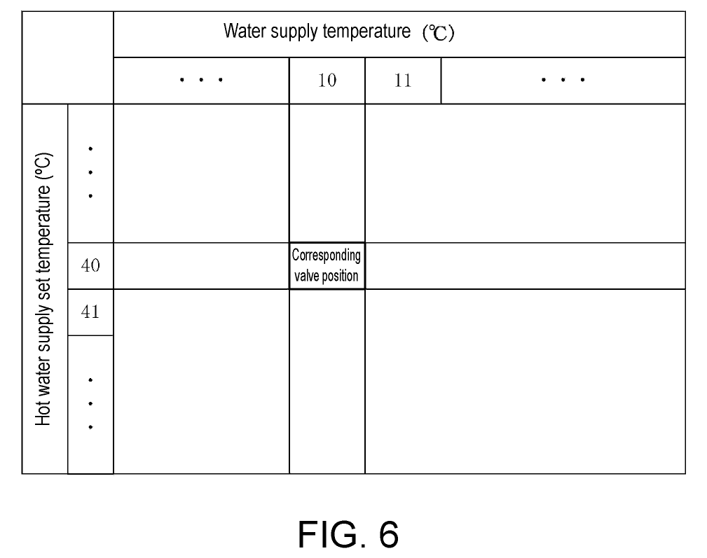

In the case where the scale accumulation estimation is started, in S1, the water supply temperature and the hot water supply set temperature are acquired, and the process proceeds to S2. Next, in S2, based on the temperature adjustment table, the valve position (standard valve position) of the valve body 40 of the water supply distribution valve 28 corresponding to the water supply temperature and the hot water supply set temperature is acquired, and the process proceeds to S3. The temperature adjustment table (standard valve position setting part), as shown in FIG. 6 for example, is one in which the valve position capable of adjusting each water supply temperature to the hot water supply set temperature is set in advance as the standard valve position through experiments and the like, and is stored in the control part 16. As the standard valve position setting part, instead of having the temperature adjustment table, the control part 16 may be configured to calculate the standard valve position corresponding to the distribution ratio capable of adjusting to the hot water supply set temperature based on the water supply temperature and the hot water supply set temperature.

In S3 of FIG. 5, the valve position of the water supply distribution valve 28 in the case where the hot water supply temperature converges to the hot water supply set temperature (converged valve position) is acquired, and the process proceeds to S4. Then, in S4, the deviation of the converged valve position acquired in S3 from the standard valve position, that is, the adjustment amount from the standard valve position to the converged valve position is calculated, and the process proceeds to S5. Since the flow rate on the hot water supply heat exchanger 22 side, where the water flow resistance increases due to scale accumulation, decreases, the water supply distribution valve 28 is adjusted such that the flow rate on the water supply bypass passage 29 side is decreased to achieve the hot water supply set temperature. Therefore, this adjustment amount reflects the flow rate of hot water on the hot water supply heat exchanger 22 side, that is, the accumulation condition of scale in the hot water supply heat exchanger 22, and the accumulation condition of scale may be estimated from the adjustment amount from the standard valve position to the converged valve position.

In S5, it is determined whether the adjustment amount calculated in S4 is within a preset adjustment normal range. Since the adjustment is made in a direction to increase the rotation angle relative to the standard valve position in order to decrease the flow rate on the water supply bypass passage 29 side, the adjustment normal range is set to a range of adjustment amount corresponding to, for example, a range within +2 degrees in rotation angle relative to the standard valve position. If the determination in S5 is Yes, the process proceeds to S6, and in S6, the process transitions to the normal mode, and the scale accumulation estimation is terminated. If the mode before the start of the scale estimation is the normal mode, the normal mode is maintained.

If the determination in S5 is No, the process proceeds to S7, and in S7, it is determined whether the adjustment amount calculated in S4 is within a preset first adjustment allowable range. The first adjustment allowable range is set to, for example, a range larger by an adjustment amount corresponding to +2 degrees in rotation angle relative to the adjustment normal range so as to allow an adjustment amount larger than the adjustment normal range. If the determination in S7 is Yes, the process proceeds to S8, and in S8, the process transitions to a first mode, and the scale accumulation estimation is terminated. The first mode is a mode in which hot water supply at the hot water supply set temperature is performed in the same manner as in the normal mode, and notification recommending scale cleaning of the hot water supply heat exchanger 22 is performed by the notification part.

On the other hand, if the determination in S7 is No, the process proceeds to S9, and in S9, it is determined whether the adjustment amount calculated in S4 is within a preset second adjustment allowable range. The second adjustment allowable range is set to, for example, a range larger by an adjustment amount corresponding to +1 degree in rotation angle relative to the first adjustment allowable range so as to allow an adjustment amount larger than the first adjustment allowable range. If the determination in S9 is Yes, the process proceeds to S10, and in S10, the process transitions to a second mode, and the scale accumulation estimation is terminated.

The second mode is a mode in which, for example, the hot water outflow temperature from the hot water supply heat exchanger 22 is lowered by reducing the flow rate of the heat medium supplied to the hot water supply heat exchanger 22 to perform hot water supply, and notification recommending scale cleaning of the hot water supply heat exchanger 22 is performed by the notification part. In the case of reducing the flow rate of the heat medium, the driving of the heating pump 15 is adjusted so as to reduce the flow rate of the heat medium, or the distribution ratio of the hot water supply heating distribution valve 20 is adjusted such that the flow rate on the heating bypass passage 21 side is reduced. Moreover, in the case where operation of heating is not being performed, the temperature of the heat medium may be lowered by reducing the amount of combustion heat generated in the combustion part 12 while maintaining the flow rate of the heat medium.

If the determination in S9 is No, the process proceeds to S11, and in S11, the process transitions to a third mode, and the scale accumulation estimation is terminated. The third mode is a mode in which hot water supply is prohibited, and notification recommending scale cleaning of the hot water supply heat exchanger 22 is performed by the notification part. The prohibition of hot water supply is performed by adjusting the valve position of the water supply distribution valve 28 to a range that closes the water supply passage 26 to stop the supply of tap water. At this time, notification of the prohibition of hot water supply may be performed together with the notification recommending scale cleaning. In the case where hot water supply is prohibited, hot water does not come out even if a hot water faucet is opened at the hot water supply destination, such that a situation in which hot water supply is not possible may be notified even when, for example, the operation terminal 34 and the hot water faucet are not installed near each other.

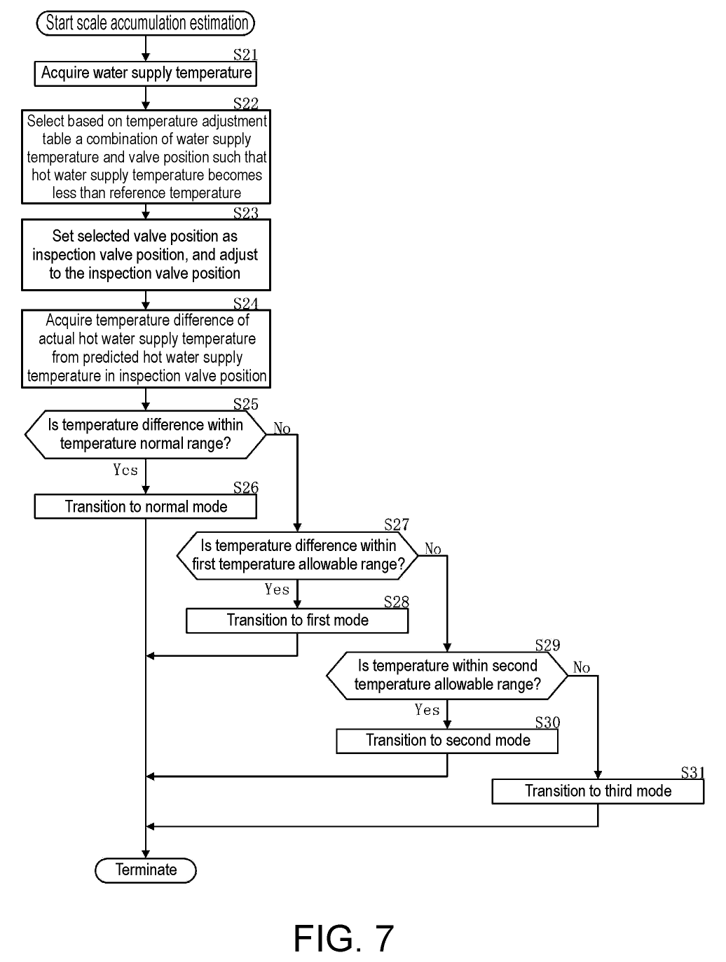

The scale accumulation estimation may also be configured to be performed by transitioning to an inspection mode for inspecting scale accumulation. In the case where the scale accumulation estimation is started in the inspection mode, the water supply temperature is acquired in S21 of FIG. 7, and the process proceeds to S22. Next, in S22, based on the temperature adjustment table (see FIG. 6), a combination of the water supply temperature and the valve position of the water supply distribution valve 28 is selected such that the hot water supply temperature becomes less than a reference temperature set as a safe temperature without risk of burns, and the process proceeds to S23. The reference temperature is, for example, 45°C, and a valve position at which the hot water supply temperature (predicted hot water supply temperature) becomes, for example, 40°C in combination with the water supply temperature is selected regardless of the current hot water supply set temperature.

In S23, the selected valve position is set as the inspection valve position, the valve position of the water supply distribution valve 28 is adjusted to the inspection valve position, and the process proceeds to S24. Then, in S24, the deviation (temperature difference) of the actual hot water supply temperature from the predicted hot water supply temperature is acquired, and the process proceeds to S25. This temperature difference reflects the flow rate of hot water heated in the hot water supply heat exchanger 22. Since this flow rate of hot water reflects the accumulation condition of scale that increases the water flow resistance of the hot water supply heat exchanger 22, the accumulation condition of scale may be estimated from the temperature difference between the predicted hot water supply temperature and the actual hot water supply temperature in the inspection mode.

In S25, it is determined whether the temperature difference acquired in S24 is within a preset temperature normal range. Since the flow rate on the hot water supply heat exchanger 22 side decreases due to scale accumulation and the hot water supply temperature decreases, the temperature normal range is set to, for example, within -1°C relative to the predicted hot water supply temperature. If the determination in S25 is Yes, the process proceeds to S26, and in S26, the process transitions to the normal mode and the inspection of scale accumulation is terminated. If the determination in S25 is No, the process proceeds to S27, and in S27, it is determined whether the deviation is within a first temperature allowable range that is larger than the temperature normal range. As the first temperature allowable range, for example, a range that is -0.5°C larger than the temperature normal range (for example, within -1.5°C relative to the predicted hot water supply temperature) is set. If the determination in S27 is Yes, the process proceeds to S28, and in S28, the process transitions to a first mode and the inspection of scale accumulation is terminated.

If the determination in S27 is No, the process proceeds to S29, and in S29, it is determined whether the deviation is within a second temperature allowable range that is larger than the first temperature allowable range. As the second temperature allowable range, for example, a range that is -0.5°C larger than the first temperature allowable range (for example, within -2°C relative to the predicted hot water supply temperature) is set. If the determination in S29 is Yes, the process proceeds to S30, and in S30, the process transitions to a second mode and the inspection of scale accumulation is terminated. If the determination in S29 is No, the process proceeds to S31, and in S31, the process transitions to a third mode and the scale accumulation estimation is terminated.

During hot water supply in this inspection mode, the hot water outflow temperature from the hot water supply heat exchanger 22 decreases due to scale accumulation, and even if the hot water supply temperature deviates from the predicted hot water supply temperature, it does not exceed the reference temperature, and the scale accumulation estimation may be safely performed in the inspection mode. The transition to this inspection mode may be performed, for example, by operation of the operation terminal 34, or the inspection made may be automatically made on a set day of the week, for example. In the case where a user starts using hot water supply in the same manner as usual without being aware of the inspection mode, the process may transition to any one of the normal mode, the first to third modes. The return from the first to third modes to the normal mode may be performed by the above-described scale accumulation estimation, but the transition to the normal mode may be possible via the operation terminal 34 in the case of performing scale cleaning.

The operation and effects of the above-described hot water supply heating device 10 will be described.

In the normal mode, the hot water supply heating device 10 performs hot water supply by mixing hot water in which tap water is heated by heat exchange with the heat medium in the hot water supply heat exchanger 22 and unheated tap water from the water supply bypass passage 29, and adjusting the distribution ratio of the water supply distribution valve 28 such that the hot water supply temperature converges to the hot water supply set temperature. In the case where the valve position of the water supply distribution valve 28 at the time when the hot water supply temperature converges to the hot water supply set temperature (converged valve position) deviates from the standard valve position of a preset temperature adjustment table corresponding to the water supply temperature and the hot water supply set temperature, the adjustment amount from the standard valve position to the converged valve position reflects the accumulation condition of scale that increases the water flow resistance of the hot water supply heat exchanger 22, so the accumulation condition of scale may be estimated from the adjustment amount of the valve position. Then, if the adjustment amount is within the adjustment normal range, the process transitions to the normal mode; if the adjustment amount is larger than the adjustment normal range but within a first adjustment allowable range, the process transitions to the first mode; if the adjustment amount is larger than the first adjustment allowable range but within a second adjustment allowable range, the process transitions to the second mode; and if the adjustment amount is larger than the second adjustment allowable range, the process transitions to the third mode.

Furthermore, in the case where the hot water supply heating device 10 has an inspection mode for estimating scale accumulation in the hot water supply heat exchanger 22, a predicted hot water supply temperature is calculated based on the inspection valve position of the water supply distribution valve 28 set in the inspection mode, the water supply temperature, and the temperature adjustment table. Then, in the case where the actual hot water supply temperature deviates from the calculated predicted hot water supply temperature, the accumulation condition of scale may be estimated from the temperature difference. If this temperature difference is within the temperature normal range, the process transitions to the normal mode; if the temperature difference is larger than the temperature normal range but within a first temperature allowable range, the process transitions to the first mode; if the temperature difference is larger than the first temperature allowable range but within a second temperature allowable range, the process transitions to the second mode; and if the temperature difference is larger than the second temperature allowable range, the process transitions to the third mode.

In the first to third modes, notification is performed to prompt cleaning of the hot water supply heat exchanger 22 before the hot water supply heat exchanger 22 becomes clogged due to scale accumulation, thereby prompting removal of the accumulated scale. Furthermore, in the first mode, hot water supply is performed in the same manner as in the normal mode, but in the second mode, the hot water outflow temperature from the hot water supply heat exchanger 22 is lowered to perform hot water supply, thereby slowing the precipitation of scale in the hot water supply heat exchanger 22 and making clogging less likely. On the other hand, in the third mode, hot water supply is prohibited before the hot water supply heat exchanger 22 becomes clogged and fails, thereby preventing a situation in which replacement of the hot water supply heat exchanger 22 becomes necessary. In this way, the hot water supply heating device 10 may perform operation according to the accumulation condition of scale as a result of the scale accumulation estimation, and may perform hot water supply while avoiding blockage.

The inspection position is set based on the temperature adjustment table and the water supply temperature such that the predicted hot water supply temperature does not exceed a reference temperature set as a safe temperature with no risk of burns. Therefore, the inspection of scale accumulation may be performed safely.

The adjustment range of the valve position of the water supply distribution valve 28 includes a distribution ratio adjustment range for adjusting the distribution ratio, a flow rate adjustment range for adjusting the flow rate, and a closing range for closing by reducing the flow rate to zero. Accordingly, in the case of transitioning to the third mode, it is possible to prevent hot water from coming out even if the hot water faucet is opened. Then, for example, even in the case where the hot water faucet and the operation terminal 34 are installed at different locations, it is possible to notify that hot water supply is not available.

Moreover, those skilled in the art may implement the disclosure in forms with various modifications added to the above embodiment without departing from the spirit of the disclosure, and the disclosure encompasses such modified forms.

What is claimed is:

1. A hot water supply heating device, comprising a heat exchanger that heats tap water supplied from a water supply passage by heat exchange with a heat medium for heating and outputs hot water to a hot water outflow passage; a distribution valve installed in the water supply passage; a bypass passage branched from the water supply passage at the distribution valve and connected to the hot water outflow passage; a control part that adjusts a distribution ratio to the heat exchanger and the bypass passage by adjusting a valve position of the distribution valve so as to supply hot water at a hot water supply set temperature; and a notification part that notifies by display or sound, the hot water supply heating device comprising:
a water supply temperature detection part that detects a water supply temperature of tap water in the water supply passage; a hot water outflow temperature detection part that detects a hot water outflow temperature of hot water at an outlet of the heat exchanger; and a hot water supply temperature detection part that detects a hot water supply temperature of hot water at a downstream side of a connection part with the bypass passage in the hot water outflow passage,
wherein the control part comprises a standard valve position setting part that sets a standard valve position of the distribution valve corresponding to a combination of the hot water supply set temperature and the water supply temperature, and when hot water is supplied in a normal mode that adjusts the valve position such that the hot water supply temperature converges to the hot water supply set temperature, in a case where an adjustment amount from the standard valve position set by the standard valve position setting part to a current valve position converged to the hot water supply set temperature exceeds a preset adjustment normal range, the control part transitions according to the adjustment amount to any one of a first mode that performs notification by the notification part to prompt cleaning of the heat exchanger and permits hot water supply similar to the normal mode; a second mode that performs the notification and permits hot water supply with a lowered hot water outflow temperature; or a third mode that performs the notification and prohibits hot water supply.

2. The hot water supply heating device according to claim 1, wherein the distribution valve comprises, in an adjustment range of the valve position, a distribution ratio adjustment range for adjusting the distribution ratio, a flow rate adjustment range for adjusting a flow rate while maintaining the distribution ratio constant, and a closing range for making the flow rate zero.

3. A hot water supply heating device, comprising a heat exchanger that heats tap water supplied from a water supply passage by heat exchange with a heat medium for heating and outputs hot water to a hot water outflow passage; a distribution valve installed in the water supply passage; a bypass passage branched from the water supply passage at the distribution valve and connected to the hot water outflow passage; a control part that adjusts a distribution ratio to the heat exchanger and the bypass passage by adjusting a valve position of the distribution valve so as to supply hot water at a hot water supply set temperature; and a notification part that notifies by display or sound, the hot water supply heating device comprising:
a water supply temperature detection part that detects a water supply temperature of tap water in the water supply passage; a hot water outflow temperature detection part that detects a hot water outflow temperature of hot water at an outlet of the heat exchanger; and a hot water supply temperature detection part that detects a hot water supply temperature of hot water at a downstream side of a connection part with the bypass passage in the hot water outflow passage,
wherein the control part comprises an inspection mode for inspecting scale accumulation in the heat exchanger, and when hot water is supplied in the inspection mode with the distribution valve set to a predetermined inspection valve position, the control part transitions, according to a temperature difference between a predicted hot water supply temperature calculated based on a distribution ratio corresponding to the inspection valve position; the water supply temperature; and the hot water outflow temperature, and an actual hot water supply temperature, to any one of a normal mode that adjusts the valve position such that the hot water supply temperature converges to the hot water supply set temperature; a first mode that performs notification by the notification part to prompt cleaning of the heat exchanger and permits hot water supply similar to the normal mode; a second mode that performs the notification and permits hot water supply with a lowered hot water outflow temperature; or a third mode that performs the notification and prohibits hot water supply.

4. The hot water supply heating device according to claim 3, wherein the distribution valve comprises, in an adjustment range of the valve position, a distribution ratio adjustment range for adjusting the distribution ratio, a flow rate adjustment range for adjusting a flow rate while maintaining the distribution ratio constant, and a closing range for making the flow rate zero.

5. The hot water supply heating device according to claim 3, wherein the control part sets the inspection valve position based on the water supply temperature such that the predicted hot water supply temperature does not exceed a preset reference temperature.

6. The hot water supply heating device according to claim 5, wherein the distribution valve comprises, in an adjustment range of the valve position, a distribution ratio adjustment range for adjusting the distribution ratio, a flow rate adjustment range for adjusting a flow rate while maintaining the distribution ratio constant, and a closing range for making the flow rate zero.
